(19) United States
(12) Patent Application Publication
(10) Pub. No.: US 2022/0166017 A1
(43) Pub. Date: May 26, 2022

(54) ELECTRODES AND ELECTROCHEMICAL CELLS INCLUDING A DENDRITE INHIBITOR PROTECTIVE COATING

(71) Applicant: GM Global Technology Operations LLC, Detroit, MI (US)

(72) Inventors: Qili SU, Shanghai (CN); Mengyan HOU, Shanghai (CN); Haijing LIU, Shanghai (CN); Zhe LI, Shanghai (CN)

(73) Assignee: GM Global Technology Operations LLC, Detroit, MI (US)

(21) Appl. No.: 17/533,936

(22) Filed: Nov. 23, 2021

(30) Foreign Application Priority Data
Nov. 24, 2020 (CN) 202011331667.1

(51) Int. Cl. H01M 4/525; H01M 4/36; H01M 4/62; H01M 10/0525; H01M 4/131; H01M 4/38

(52) U.S. Cl. CPC H01M 4/525; H01M 4/366; H01M 4/623; H01M 4/625; H01M 2004/027; H01M 10/0525; H01M 4/131; H01M 4/382; H01M 4/626

(57) ABSTRACT

A negative electrode and an electrochemical cell are provided herein. The negative electrode and the electrochemical cell include a protective coating for preventing and inhibiting growth of lithium dendrite on the negative electrode and growth into a separator. The protective coating includes a first layer and second layer. The first layer includes a first polymeric binder and an optional insulating material. The second layer includes a dendrite consuming material and a second polymeric binder.

### CROSS-REFERENCE TO RELATED APPLICATIONS

The present disclosure claims priority to Chinese Application No. 202011331667.1, filed Nov. 24, 2020. The entire disclosure of the above application is incorporated herein by reference.

### FIELD

The present disclosure relates to electrodes and electrochemical cells including a protective coating, which includes a first layer and a second layer and can inhibit dendrite growth.

### BACKGROUND

This section provides background information related to the present disclosure which is not necessarily prior art.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode of opposite polarity (e.g., an anode), an electrolyte material, and a separator. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery. For convenience, a negative electrode will be used synonymously with an anode, although as recognized by those of skill in the art, during certain phases of lithium ion cycling the anode function may be associated with the positive electrode rather than negative electrode (e.g., the negative electrode may be an anode on discharge and a cathode on charge).

In various aspects, an electrode includes an electroactive material. Negative electrodes typically comprise such an electroactive material that is capable of functioning as a lithium host material serving as a negative terminal of a lithium ion battery. Conventional negative electrodes include the electroactive lithium host material and optionally another electrically conductive material, such as carbon black particles, as well as one or more polymeric binder materials to hold the lithium host material and electrically conductive particles together.

Lithium ion batteries can reversibly supply power to an associated load device on demand. More specifically, electrical power can be supplied to a load device by a lithium ion battery until the lithium content of the negative electrode is effectively depleted. The battery may then be recharged by passing a suitable direct electrical current in the opposite direction between the electrodes.

During discharge, the negative electrode may contain a relatively high concentration of intercalated lithium, which is oxidized into lithium ions and electrons. The lithium ions travel from the negative electrode (anode) to the positive electrode (cathode), for example, through the ionically conductive electrolyte solution contained within the pores of an interposed porous separator. At the same time, the electrons pass through the external circuit from the negative electrode to the positive electrode. The lithium ions may be assimilated into the material of the positive electrode by an electrochemical reduction reaction. The battery may be recharged after a partial or full discharge of its available capacity by an external power source, which reverses the electrochemical reactions that transpired during discharge.

During recharge, intercalated lithium in the positive electrode is oxidized into lithium ions and electrons. The lithium ions travel from the positive electrode to the negative electrode through the porous separator via the electrolyte, and the electrons pass through the external circuit to the negative electrode. The lithium cations are reduced to elemental lithium at the negative electrode and stored in the material of the negative electrode for reuse.

During this discharge-recharge procedure, degradation of the active materials (e.g. negative electrode, positive electrode, and electrolyte) can occur as well as metal lithium plating and the formation of lithium dendrites, surface deposits of lithium on the negative electrode. Over time, these dendrites can grow into and penetrate the separator and result in low Coulombic efficiency, poor cycle performance, and potential safety issues for the battery. This growth of dendrites can be particularly problematic for high power batteries that undergo high power regeneration pulses.

It would be desirable to develop high power regenerable electrochemical cell materials, which overcome the current shortcomings that prevent their widespread commercial use, especially in vehicle applications. Accordingly, it would be desirable to develop electrochemical cell materials that are capable of preventing and/or mitigating lithium dendrite growth in commercial lithium ion batteries with long lifespans, especially for transportation applications.

### SUMMARY

This section provides a general summary of the disclosure and is not a comprehensive disclosure of its full scope or all of its features.

In certain aspects, the present disclosure provides a negative electrode. The negative electrode includes a negative electrode layer including a first electroactive material, and a protective coating adjacent to at least a portion of a first surface of the negative electrode layer. The protective coating includes a first layer adjacent to at least a portion of the first surface of the negative electrode layer and a second layer adjacent to at least a portion of a second surface of the first layer. The first layer includes a first polymeric binder, and optionally, an insulating material selected from the group consisting of a lithium ion conductive material, a ceramic filler material, and a combination thereof. The first layer has an electronic conductivity of less than or equal to about 10⁻⁵ S/cm. The second layer includes a second polymeric binder and a dendrite consuming material selected from the group consisting of a lithium ion host material, a capacitor material, a lithium reactive metal, a lithium reactive inorganic component, and a combination thereof.

The first electroactive material is selected from the group consisting of lithium, a lithium silicon alloy, a lithium aluminum alloy, a lithium indium alloy, graphite, activated carbon, carbon black, hard carbon, soft carbon, graphene, silicon, silicon alloy, tin oxide, aluminum, indium, zinc, germanium, silicon oxide, titanium oxide, lithium titanate, and a combination thereof.

The first polymeric binder is present in the first layer in an amount of about 0.5 wt % to about 100 wt %, based on total weight of the first layer, and the insulating material is present in the first layer in an amount of about 0 wt % to about 99.5 wt %, based on total weight of the first layer.

The first polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof. The lithium ion conductive material is selected from the group consisting of a garnet ceramic material, a lithium super ionic conductor (LISICON) oxide, a sodium super ionic conductor (NASICON) oxide, a perovskite ceramic material, an antiperovskite ceramic material and a combination thereof. The ceramic filler material is selected from the group consisting of SiO₂, Al₂O₃, TiO₂, AlN, Al₂O₃, SiC, Si₃N₄, Sr₂Ce₂Ti₅O₁₆, ZrSiO₄, CaSiO₃, SiO₂, BeO, CeO₂, BN, ZnO, and a combination thereof.

The second polymeric binder is present in the second layer in an amount of about 0.5 wt % to about 5 wt %, based on total weight of the second layer, and the dendrite consuming material is present in the second layer in an amount of about 90 wt % to about 99.5 wt %, based on total weight of the second layer.

The second polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof;

The lithium ion host material is selected from the group consisting of Li₄Ti₅O₁₂, TiₓNb_{y}O_{z} where 1/24≤x/y≤1 and z=(4*x+5*y)/2, TiS₂, TiO₂, Nb₂O₅, and a combination thereof. The capacitor material is selected from the group consisting of activated carbon, a metal oxide, a metal sulfide, a conductive polymer, and a combination thereof. The lithium reactive metal is selected from the group consisting of tin, manganese, aluminum, sulfur, silver-carbon, and a combination thereof. The lithium reactive inorganic component is selected from the group consisting of Li₁₊ₓAlₓTi₂₋ₓ(PO₄)₃ where 0≤x≤2.

The second layer further comprises an electrically conductive material selected from the group consisting of carbon black, super P carbon black, acetylene black, graphite, carbon nanotubes, carbon fibers, graphene, graphene oxide, vapor grown carbon fibers, nitrogen-doped carbon, a metallic powder, a liquid metal, and combinations thereof. The electrically conductive material is present in the second layer in an amount of about 0.5 wt % to about 5 wt %, based on total weight of the second layer.

The insulating material has an average particle size diameter of about 20 nm to about 500 nm, and the dendrite consuming material has an average particle size diameter of about 20 nm to about 500 nm.

The first layer has a thickness of about 1 μm to about 10 μm and the second layer has a thickness of about 1 μm to about 10 μm.

In yet other aspects, the present disclosure provides an electrochemical cell. The electrochemical cell includes a negative electrode layer comprising a first electroactive material, and a positive electrode layer comprising a second electroactive material, wherein the positive electrode layer is spaced apart from the negative electrode layer. The electrochemical cell further includes a porous separator disposed between confronting surfaces of the negative electrode layer and the positive electrode layer, at least one protective coating disposed between confronting surfaces of the porous separator and the negative electrode layer, and a liquid electrolyte infiltrating the negative electrode layer, the positive electrode layer, and the porous separator. The protective coating includes a first layer adjacent to at least a portion of the first surface of the negative electrode layer and a second layer adjacent to at least a portion of a second surface of the first layer. The first layer includes a first polymeric binder, and optionally, an insulating material selected from the group consisting of a lithium ion conductive material, a ceramic filler material, and a combination thereof. The first layer has an electronic conductivity of less than or equal to about 10⁻⁵ S/cm. The second layer includes a second polymeric binder and a dendrite consuming material selected from the group consisting of a lithium ion host material, a capacitor material, a lithium reactive metal, a lithium reactive inorganic component, and a combination thereof.

The first electroactive material is selected from the group consisting of lithium, a lithium silicon alloy, a lithium aluminum alloy, a lithium indium alloy, graphite, activated carbon, carbon black, hard carbon, soft carbon, graphene, silicon, silicon alloy, tin oxide, aluminum, indium, zinc, germanium, silicon oxide, titanium oxide, lithium titanate, and a combination thereof. The second electroactive material is selected from the group consisting of Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FePO₄F; LiMn₂O₄; LiFeSiO₄; LiNi_{0.6}Mn_{0.2}Co_{0.2}O₂ (NMC622), LiMnO₂ (LMO), activated carbon, sulfur, and a combination thereof.

The first layer is formed on the first surface of the negative electrode layer and the second layer is formed on the second surface of the first layer. Alternatively, the first layer is formed on the first surface of the negative electrode layer and the second layer is formed on a third surface of the porous separator. Alternatively, the second layer is formed on the third surface of the porous separator and the first layer is formed on a fourth surface of the second layer.

The first polymeric binder is present in the first layer in an amount of about 0.5 wt % to about 100 wt %, based on total weight of the first layer, and the insulating material is present in the first layer in an amount of about 0 wt % to about 99.5 wt %, based on total weight of the first layer.

The first polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof. The lithium ion conductive material is selected from the group consisting of a garnet ceramic material, a lithium super ionic conductor (LISICON) oxide, a sodium super ionic conductor (NASICON) oxide, a perovskite ceramic material, an antiperovskite ceramic material and a combination thereof. The ceramic filler material is selected from the group consisting of SiO₂, Al₂O₃, TiO₂, AlN, Al₂O₃, SiC, Si₃N₄, Sr₂Ce₂Ti₅O₁₆, ZrSiO₄, CaSiO₃, SiO₂, BeO, CeO₂, BN, ZnO, and a combination thereof.

The second polymeric binder is present in the second layer in an amount of about 0.5 wt % to about 5 wt %, based on total weight of the second layer, and the dendrite consuming material is present in the second layer in an amount of about 90 wt % to about 99.5 wt %, based on total weight of the second layer.

The second polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof. The lithium ion host material is selected from the group consisting of Li₄Ti₅O₁₂, TiₓNb_{y}O_{z} where 1/24≤x/y≤1 and z=(4*x+5*y)/2, TiS₂, TiO₂, Nb₂O₅, and a combination thereof. The capacitor material is selected from the group consisting of activated carbon, a metal oxide, a metal sulfide, a conductive polymer, and a combination thereof. The lithium reactive metal is selected from the group consisting of tin, manganese, aluminum, sulfur, silver-carbon, and a combination thereof. The lithium reactive inorganic component is selected from the group consisting of Li₁₊ₓAlₓTi₂₋ₓ(PO₄)₃ where 0≤x≤2.

The second layer further comprises an electrically conductive material selected from the group consisting of carbon black, super P carbon black, acetylene black, graphite, carbon nanotubes, carbon fibers, graphene, graphene oxide, vapor grown carbon fibers, nitrogen-doped carbon, a metallic powder, a liquid metal, and combinations thereof. The electrically conductive material is present in the second layer in an amount of about 0.5 wt % to about 5 wt %, based on total weight of the second layer.

The insulating material has an average particle size diameter of about 20 nm to about 500 nm and the dendrite consuming material has an average particle size diameter of about 20 nm to about 500 nm.

The first layer has a thickness of about 1 μm to about 10 μm and the second layer has a thickness of about 1 μm to about 10 μm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell according to an aspect of the disclosure;

FIG. 2 is a cross-sectional view of a negative electrode with a protective coating according to another aspect of the disclosure;

FIG. 3 is a cross-sectional view of a negative electrode and a separator with a protective coating according to another aspect of the disclosure;

FIG. 4 is a cross-sectional view of a negative electrode and a separator with a protective coating according to another aspect of the disclosure;

FIG. 5 is a partial perspective view of a lithium ion battery including a plurality of stacked electrochemical cells according to one aspect of the disclosure;

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure pertains to high-performance lithium ion electrochemical cells (e.g., lithium ion batteries) having improved electrodes and methods of making the same. In lithium ion electrochemical cells or batteries, a negative electrode typically includes a lithium insertion material or an alloy host material. As discussed above, conventional electroactive materials for forming a negative electrode or anode include lithium-graphite intercalation compounds, lithium-silicon alloys, lithium-tin compounds, and other lithium alloys. Graphite compounds are most commonly used, but silicon (Si), silicon oxide, and tin are attractive alternatives to graphite as an anode material for rechargeable lithium ion batteries due to their high theoretical capacity. During the discharge-recharge cycle(s), lithium dendrites can form on the surface of the negative electrode and over time, these dendrites can grow into and penetrate the separator. Formation of dendrites can result in low Coulombic efficiency, poor cycle performance, and potential safety issues for the battery. Thus, electrode and electrochemical cell designs are needed, which can inhibit and/or prevent dendrite growth.

The present disclosure pertains to improved negative electrodes for lithium ion electrochemical cells (e.g., lithium ion batteries) and improved lithium ion electrochemical cells including a protective coating comprising a first layer and a second layer. It has been discovered that a protective coating including a combination of first layer capable of electronic insulation and a second layer capable of consuming dendrites can advantageously prevent and/or reduce lithium dendrite growth and mossy lithium formation on the negative electrode and penetration into the separator. In various aspects, a first layer as described in more detail below can physically block formation of dendrites from penetrating a separator and a second layer as described in more detail below can chemically react or consume the formed dendrites thereby suppressing lithium dendrite growth and mossy lithium formation and improving cycle efficiency of an electrochemical cell.

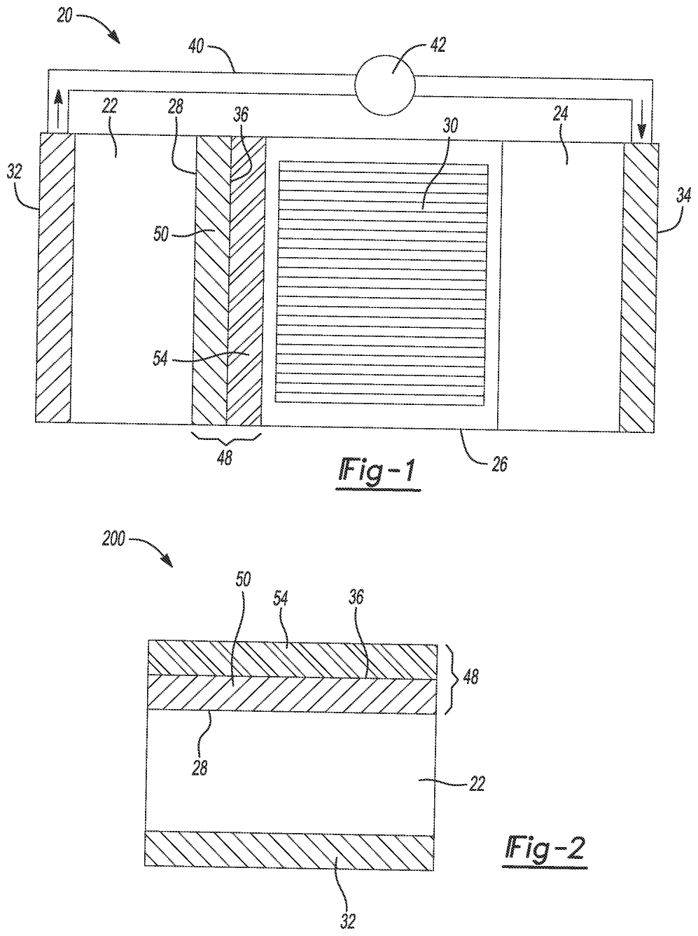

For example, an exemplary and schematic illustration of an electrochemical cell (also referred to as the lithium ion battery or battery) 20 is shown in FIG. 1. Lithium ion battery 20 includes a negative electrode layer (also referred to as the negative electrode) 22, a positive electrode layer (also referred to as the positive electrode) 24, and a separator 26 (e.g., a microporous polymeric separator) disposed between the two electrodes 22, 24. The lithium ion battery 20 also includes at least one protective coating 48 disposed between confronting surfaces of the separator 26 and the negative electrode layer 22. The protective coating 48 includes a first layer 50 adjacent to at least a portion of a first surface 28 of the negative electrode layer 22 and a second layer 54 adjacent to at least a portion of a second surface 36 of the first layer 50. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. In alternative embodiments, a separator 26 is not included if a solid electrolyte is used. A negative electrode current collector 32 may be positioned at or near the negative electrode 22, and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the lithium ion battery 20. The separator 26 also contains the electrolyte solution in a network of open pores during the cycling of lithium ions, to facilitate functioning of the battery 20.

As described above, the protective coating 48 including a combination of the first layer 50 and the second layer 54 can advantageously prevent and/or reduce lithium dendrite growth and mossy lithium formation on the negative electrode and penetration of the lithium dendrite into the separator. The first layer 50 is formed of a material capable of electronic insulation and can be capable of blocking growth of lithium dendrites so that lithium dendrites are prevented from penetrating into the separator. The second layer 54 is formed of a material capable of chemically reacting with lithium dendrites and mitigating and/or stopping further growth of the lithium dendrite.

In any embodiment, the first layer 50 includes a first polymeric binder and optionally, an insulating material. Examples of a suitable first polymeric binder include, but are not limited, to polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and combinations thereof. In any embodiment, the first layer 50 can include only a first polymeric binder, for example, about 100 wt % of the first polymeric binder, based on total weight of the first layer 50. Alternatively, a first polymeric binder may be present in the first layer 50 in an amount, based on total weight of the first layer 50, of greater than or equal to about 0.5 wt %, greater than or equal to about 10 wt %, greater than or equal to about 25 wt %, greater than or equal to about 40 wt % greater than or equal to about 50 wt %, greater than or equal to about 75 wt %, greater than or equal to about 90 wt %, greater than or equal to about 95 wt %, or greater than or equal to about 99 wt %; or from about 0.5 wt % to about 100 wt %, about 10 wt % to about 100 wt %, about 25 wt % to about 100 wt %, about 50 wt % to about 100 wt %, about 0.5 wt % to about 95 wt %, about 5 wt % to about 95 wt %, about 10 wt % to about 90 wt %, about 25 wt % to about 75 wt %, or about 50 wt % to about 90 wt %.

In any embodiment, the first layer may have a lower electronic conductivity, for example, less than or equal to about 10⁻² siemens per centimeter (S/cm), less than or equal to about 10⁻³ S/cm, less than or equal to about 10⁻⁴ S/cm, less than or equal to about 10⁻⁵ S/cm, less than or equal to about 10⁻⁶ S/cm, less than or equal to about 10⁻⁷ S/cm, less than or equal to about 10⁻⁸ S/cm, less than or equal to about 10⁻⁹ S/cm, less than or equal to about 10⁻¹⁰ S/cm, less than or equal to about 10⁻¹² S/cm; less than or equal to about 10⁻¹⁴ S/cm, or about 10⁻¹⁵ S/cm; or from about 10⁻¹⁵ S/cm to about 10⁻² S/cm, about 10⁻¹² S/cm to about 10⁻² S/cm, about 10⁻¹⁰ S/cm to about 10⁻² S/cm, about 10⁻¹⁰ S/cm to about 10⁻³ S/cm, about 10⁻¹⁰ S/cm to about 10⁻⁴ S/cm, about 10⁻¹⁰ S/cm to about 10⁻⁵ S/cm, or about 10⁻⁸ S/cm to about 10⁻⁵ S/cm. Electronic conductivity of the first layer and/or second layer can be calculated according to the equation, s₁=L/(A×R), where s₁ represents electronic conductivity, L represents thickness of the layer, A represents cross-sectional area of the layer, and R represents measured or known resistance.

In any embodiment, the insulating material can be a lithium ion conductive material, a ceramic filler material, or a combination thereof. Suitable lithium ion conductive materials include oxide-based materials, such as solid electrolyte materials. For example, the lithium ion conductive material may be a garnet ceramic material, a lithium super ionic conductor (LISICON) oxide, a sodium super ionic conductor (NASICON) oxide, a perovskite ceramic material, an antiperovskite ceramic material or combinations thereof. For example, the one or more garnet ceramics may be selected from the group consisting of: Li_{6.5}La₃Zr_{1.75}Te_{0.25}O₁₂, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₅La₃M₂O₁₂ (where M is one of Nb and Ta), and combinations thereof. The one or more LISICON oxides may be selected from the group consisting of: Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The one or more NASICON oxides may be defined by LiMM′(PO₄)₃, where M and M′ are independently selected from Al, Ge, Ti, Sn, Hf, Zr, and La. For example, in certain variations, the one or more NASICON oxides may be selected from the group consisting of: Li₁₊ₓAlₓGe₂₋ₓ(PO₄)₃ (LAGP) (where 0≤x≤2), Li₁₊ₓAlₓTi₂₋ₓ(PO₄)₃ (LATP) (where 0≤x≤2), Li₁₊ₓYₓZr₂₋ₓ(PO₄)₃ (LYZP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, LiTi_{0.5}Zr_{1.5})(PO₄)₃, and combinations thereof. The one or more perovskite ceramics may be selected from the group consisting of: Li_{3.3}La_{0.56}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li_{0.5}M_{0.5}TiO₃ (where M is one of Sm, Nd, Pr, and La), and combinations thereof. The one or more antiperovskite ceramics may be selected from the group consisting of: Li₃OCl, Li₃OBr, and combinations thereof. In each instance, however, the one or more lithium ion conductive materials may have an ionic conductivity greater than or equal to about 10⁻⁷ siemens per centimeter (S/cm), greater than or equal to about 10⁻⁶ S/cm, greater than or equal to about 10⁻⁵ S/cm, greater than or equal to about 10⁻⁴ S/cm, or less than or equal to about 10⁻¹ S/cm, less than or equal to about 10⁻² S/cm, less than or equal to about 10⁻³ S/cm; or greater than or equal to about 10⁻⁷ S/cm to less than or equal to about 10⁻¹ S/cm, greater than or equal to about 10⁻⁶ S/cm to less than or equal to about 10⁻³ S/cm, or greater than or equal to about 10⁻⁵ S/cm to less than or equal to about 10⁻³ S/cm. Ionic conductivity of the lithium ion conductive material can be calculated according to the equation, s₂=L/(R×S), where s₂ represents ionic conductivity, L represents bulk pellet material thickness, S represents cross-sectional area of the bulk pellet material, and R represents measured (e.g., via electrochemical impedance spectroscopy) or known bulk material pellet resistance.

Suitable ceramic filler materials include, but are not limited to metal oxides. For example, one or more ceramic filler materials may be selected from the group consisting of SiO₂, Al₂O₃, TiO₂, AlN, Al₂O₃, SiC, Si₃N₄, Sr₂Ce₂Ti₅O₁₆, zirconium silicate (ZrSiO₄), wollastonite (CaSiO₃), silicon dioxide (SiO₂), beryllium oxide (BeO), CeO₂, boron nitride (BN), ZnO, and combinations thereof.

The insulating materials may be present as particles having an average particle size diameter of greater than or equal to about 1 nm, greater than or equal to about 20 nm, greater than or equal to about 50 nm, greater than or equal to about 100 nm, greater than or equal to about 150 nm, greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, or about 600 nm; or from about 1 nm to about 600 nm, about 20 nm to about 500 nm, or about 100 nm to about 500 nm.

In some embodiments, no insulating material may be present in the first layer 50, for example, 0 wt % of insulating material, based on total weight of the first layer 50. Alternatively, an insulating material may be present in the first layer 50 in an amount, based on total weight of the first layer, of greater than or equal to about 0.5 wt %, greater than or equal to about 10 wt %, greater than or equal to about 25 wt %, greater than or equal to about 40 wt % greater than or equal to about 50 wt %, greater than or equal to about 75 wt %, greater than or equal to about 90 wt %, greater than or equal to about 95 wt %, or about 99.5 wt %; or from about 0.5 wt % to about 99.5 wt %, about 10 wt % to about 99.5 wt %, about 25 wt % to about 99.5 wt %, about 50 wt % to about 99.5 wt %, about 0.5 wt % to about 95 wt %, about 10 wt % to about 90 wt %, about 25 wt % to about 75 wt %, or about 50 wt % to about 90 wt %.

In any embodiment, the second layer 54 includes a second polymeric binder and a dendrite consuming material. Examples of a suitable second polymeric binder include, but are not limited to, polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and combinations thereof. In some embodiments, the second polymeric binder is PVDF. In any embodiment, a second polymeric binder may be present in the second layer 54 in an amount, based on total weight of the second layer 54, of less than or equal to about 10 wt %, less than or equal to about 7.5 wt %, less than or equal to about 5 wt %, less than or equal to about 2.5 wt %, less than or equal to about 1 wt %, or about 0.5 wt %; or from about 0.5 wt % to about 10 wt %, about 0.5 wt % to about 7.5 wt %, about 0.5 wt % to about 5 wt %, about 0.5 wt % to about 2.5 wt %, about 0.5 wt % to about 1 wt %.

In various aspects, the second layer 54 can have a higher electronic conductivity, for example, higher electronic conductivity than the first layer 50. Additionally, the dendrite consuming material may have higher chemical potential than the negative electrode electroactive material and possess high chemical stability. For example, the chemical potential difference between the dendrite consuming material and the negative electrode electroactive material can be from about 0.05 V to about 3 V. The dendrite consuming material may be selected from the group consisting of a lithium ion host material, a capacitor material, a lithium reactive metal, a lithium reactive inorganic component, and combinations thereof. Non-limiting examples of a lithium ion host material include Li₄Ti₅O₁₂, TiₓNb_{y}O_{z} where 1/24≤x/y≤1 and z=(4*x+5*y)/2 (e.g., TiNb₂O₇, Ti₂Nb₁₀O₂₉, TiNb₆O₁₇,TiNb₂₄O₆₂), TiS₂, TiO₂, Nb₂O₅, and combinations thereof. Non-limiting examples of a capacitor material include activated carbon, a metal oxide (e.g., MnO₂, Fe₂O₃, Co₃O₄, and the like), a metal sulfide (e.g., FeS, TiS₂, MnS, and the like), a conductive polymer, and combinations thereof. Examples of a conductive polymer include polyaniline, polythiophene, polyacetylene, poly(pyrrole, and the like. A lithium reactive metal include any metal that can react with lithium to form metal lithium alloy in a low electrochemical potential, for example, tin, manganese, aluminum, sulfur, silver-carbon, and combinations thereof. Non-limiting examples of a lithium reactive inorganic component include Li₁₊ₓAlₓTi₂₋ₓ(PO₄)₃, where 0≤x≤2.

The dendrite consuming material may be present as particles having an average particle size diameter of greater than or equal to about 1 nm, greater than or equal to about 20 nm, greater than or equal to about 50 nm, greater than or equal to about 100 nm, greater than or equal to about 150 nm, greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, or about 600 nm; or from about 1 nm to about 600 nm, about 20 nm to about 500 nm, or about 100 nm to about 500 nm.

In any embodiment, the dendrite consuming material may be present in the second layer 54 in an amount, based on total weight of the second layer 54, of greater than or equal to about 75 wt %, greater than or equal to about 90 wt %, greater than or equal to about 95 wt %, or greater than or equal to about 99 wt % or about 99.5 wt %; or from about 75 wt % to about 99.5 wt %, about 90 wt % to about 99.5 wt %, or about 95 wt % to about 99.5 wt %.

In some embodiments, the second layer 54 may further include an electrically conductive material. Non-limiting examples of the electrically conductive material include carbon black, super carbon P, graphite, acetylene black (such as KETCHEN™ black or DENKA™ black), carbon nanotubes, carbon fibers, vapor grown carbon fibers, graphene, graphene oxide, nitrogen-doped carbon, metallic powder (e.g., copper, nickel, steel), liquid metals (e.g., Ga, GaInSn), and combinations thereof. The electrically conductive material may be present in the second layer 54 in an amount, based on total weight of the second layer 54, of less than or equal to about 10 wt %, less than or equal to about 7.5 wt %, less than or equal to about 5 wt %, less than or equal to about 2.5 wt %, less than or equal to about 1 wt %, less than or equal to about 0.5 wt %; or from about 0.5 wt % to about 10 wt %, about 0.5 wt % to about 7.5 wt %, about 0.5 wt % to about 5 wt %, about 0.5 wt % to about 2.5 wt %, about 0.5 wt % to about 1 wt %.

The first layer 50 and the second layer 54 may be any suitable thickness. For example, the first layer 50 and the second layer 54 may each independently have a thickness of greater than or equal to about 10 nm, greater than or equal to about 100 nm, greater than or equal to about 1 μm, greater than or equal to about 2.5 μm, greater than or equal to about 5 μm, greater than or equal to about 7.5 μm, greater than or equal to about 10 μm, greater than or equal to about 15 μm, or about 25 μm; or from about 10 nm to about 25 μm, about 100 nm to about 15 μm, about 1 μm to about 15 μm, about 1 μm to about 10 μm, or about 5 μm to about 10 μm. In some embodiments, the first layer 50 and the second layer 54 may have the same thickness, the first layer 50 may have a thickness greater than the second layer 54, or the second layer 54 may have a thickness greater than the first layer 50. It is contemplated herein that the first layer 50 and the second layer 54 can each be substantially continuous layers or discontinuous layers.

The first layer 50 and the second layer 54 can be formed via methods well known to those of ordinary skill. Such methods include, but are not limited to slot die coating, doctor blade coating, and spray coating. For example, to form the first layer 50, a first polymeric binder, a solvent, and optionally one or more insulating materials as described herein can be mixed together to form a solution or slurry, which can be applied via the aforementioned coating methods, for example, to the surface of the negative electrode, and optionally, volatilized. Similarly, to form the second layer 54, a second polymeric binder can be mixed with a one or more dendrite consuming materials as described herein, a solvent, and optionally an electrically conductive material as described herein to a form a solution or slurry, which can be applied via the aforementioned coating methods, for example, to a surface of the first layer 50, and optionally, volatilized. As used herein, the term “polymeric binder” includes polymer precursors used to form the polymeric binder, for example, monomers or monomer systems that can form the any one of the polymeric binders disclosed above and or includes polymer precursors used to form the polymeric binder. Non-limiting examples of suitable solvents include N-methyl-2-pyrrolidone (NMP), dimethylformamide (DMF), dimethyl sulfoxide (DMSO), propylene carbonate (PC), acetonitrile (CAN), tetrahydrofuran (THF) and combinations thereof. In some embodiments, the solvent may be aprotic, preferably polar. The various materials can be blended or mixed by equipment known in the art, such as for example, magnetic stirrers, mixers, kneaders, and the like. In some embodiments, after coating the first layer 50 and/or after coating the second layer 54, the first layer 50 and/or the second layer 54 may be pressed or calendered.

Additionally, the first layer 50 and the second layer 54 may be formed in various configurations on the negative electrode layer 22 and the separator 26. For example, as illustrated in FIG. 2, a negative electrode 200 is provided herein including negative electrode layer 22, negative electrode current collector 32, and protective coating 48 disposed on or adjacent to at least a portion of a first surface 28 of the negative electrode layer 22. The first layer 50 as described herein may be disposed on, adjacent to, or formed on at least a portion of a first surface 28 of the negative electrode layer 22, and the second layer 54 as described herein may be disposed on, adjacent to, or formed on at least a portion of a second surface 36 of the first layer 50.

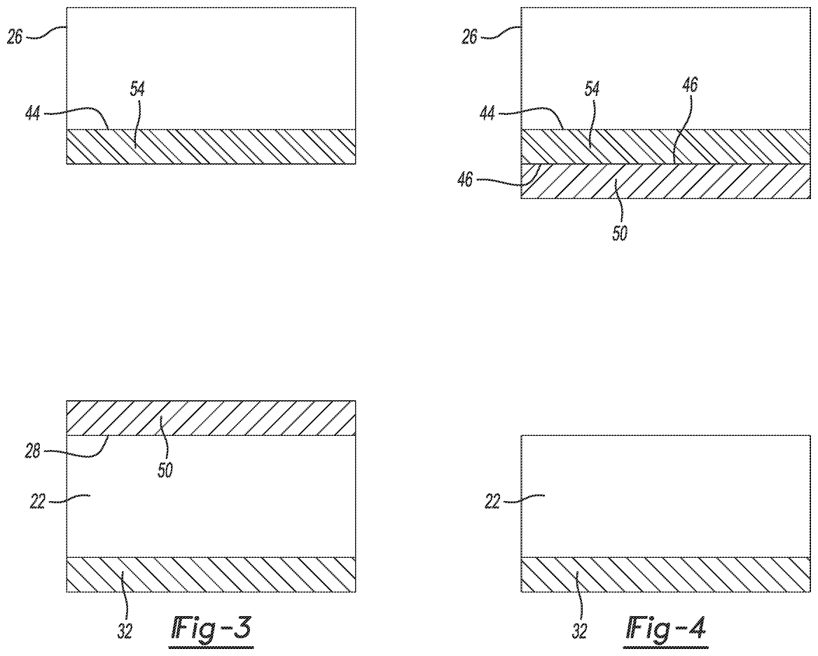

Alternatively, as illustrated in FIG. 3, the first layer 50 as described herein may be disposed on, adjacent to, or formed on at least a portion of a first surface 28 of the negative electrode layer 22, and the second layer 54 as described herein may be disposed on, adjacent to, or formed on at least a portion of a third surface 44 of the separator 26. Upon assembly of the electrochemical cell, first layer 50 may be disposed or adjacent to second layer 54.

A further alternative configuration is illustrated in FIG. 4, where the second layer 54 as described herein may be disposed on, adjacent to, or formed on at least a portion of a third surface 44 of the separator 26 and the first layer 50 as described herein may be disposed on, adjacent to, or formed on at least a portion of a fourth surface 46 of the second layer 54. Upon assembly of the electrochemical cell, first layer 50 may be disposed or adjacent to negative electrode 22.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

With renewed reference to FIG. 1, the lithium ion battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the inserted lithium in the negative electrode 22 is depleted and the capacity of the lithium ion battery 20 is diminished.

The lithium ion battery 20 can be charged or re-powered/re-energized at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with inserted lithium for consumption during the next battery discharge event. As such, a complete discharging event followed by a complete charging event is considered to be a cycle, where lithium ions are cycled between the positive electrode 24 and the negative electrode 22. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. It is contemplated herein that the lithium ion battery 20 may be charged with a high power regeneration pulse.

In many lithium ion battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package. The negative electrode current collector 32 and positive electrode current collector 34 respectively collect and move free electrons to and from an external circuit 40.

Furthermore, the lithium ion battery 20 can include a variety of other components that while not depicted here are nonetheless known to those of skill in the art. For instance, the lithium ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

As noted above, the size and shape of the lithium ion battery 20 may vary depending on the particular application for which it is designed. Battery-powered vehicles and hand-held consumer electronic devices, for example, are two examples where the lithium ion battery 20 would most likely be designed to different size, capacity, and power-output specifications. The lithium ion battery 20 may also be connected in series or parallel with other similar lithium ion cells or batteries to produce a greater voltage output and power density if it is required by the load device 42.

Accordingly, the lithium ion battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the lithium ion battery 20 for purposes of storing energy.

The positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G3)(TFSI), lithium bis(trifluoromethanesulfonyl)azanide (LiTFSA), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), acetonitrile, and combinations thereof.

The separator 26 may comprise, for example, a microporous polymeric separator comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), poly(propylene (PP), or a blend of PE and PP, or multi-layered structured porous films of PE and/or PP. Commercially available polyolefin porous separator membranes include CELGARD® 2500 (a monolayer poly(propylene separator) and CELGARD® 2320 (a trilayer poly(propylene/polyethylene/poly(propylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. By way of non-limiting example, SSEs may include LiTi₂(PO₄)₃, LiGe₂(PO₄)₃, Li₇La₃Zr₂O₁₂, Li₃ₓLa_{2/3-x}TiO₃, Li₃PO₄, Li₃N, Li₄GeS₄, Li₁₀GeP₂Si₂, Li₂S—P₂S₅, Li₆PS₅Cl, Li₆PS₅Br, Li₆PS₅I, Li₃OCl, Li_{2.99}Ba_{0.005}ClO, or combinations thereof.

In various aspects, the negative electrode layer 22 includes an electroactive material (also referred to as a first electroactive material) as a lithium host material capable of functioning as a negative terminal of a lithium ion battery. The first electroactive material may be formed from or comprise lithium, a lithium silicon alloy, a lithium aluminum alloy, a lithium indium alloy, graphite, activated carbon, carbon black, hard carbon, soft carbon, graphene, silicon, tin oxide, aluminum, indium, zinc, germanium, silicon oxide, titanium oxide, lithium titanate, and combinations thereof, for example, silicon mixed with graphite. Non-limiting examples of silicon-containing electroactive materials include silicon (amorphous or crystalline), or silicon containing binary and ternary alloys, such as Si—Sn, SiSnFe, SiSnAl, SiFeCo, and the like.

The negative electrode current collector 32 may comprise a metal comprising copper, nickel, or alloys thereof or other appropriate electrically conductive materials known to those of skill in the art. The negative electrode 22 can optionally include electrically conductive material (also referred to as “electrically conductive filler material”), as well as one or more polymeric binder materials to structurally hold the lithium host material together. Such negative electroactive materials may be intermingled with the electrically conductive material and at least one polymeric binder. The polymeric binder can create a matrix retaining the negative electroactive materials and electrically conductive material in position within the electrode. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

The positive electrode layer 24 may be formed from or comprise a lithium-based active material (also referred to as a second electroactive material) that can sufficiently undergo lithium intercalation and deintercalation while functioning as the positive terminal of the lithium ion battery 20. The positive electrode layer 24 may also include a polymeric binder material to structurally fortify the lithium-based active material and an electrically conductive material. Exemplary common classes of known materials that can be used to form the positive electrode 24 are layered lithium transitional metal oxides and spinel materials. For example, in certain embodiments, the positive electrode 24 may comprise at Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FePO₄F; LiMn₂O₄; LiFeSiO₄; LiNi_{0.6}Mn_{0.2}Co_{0.2}O₂ (NMC622), LiMnO₂ (LMO), activated carbon, sulfur (e.g., greater than 60 wt % based on total weight of the positive electrode), and combinations thereof, and combinations thereof. It is contemplated herein that the second electroactive material for use in the positive electrode encompasses doped and/or coated variations of the aforementioned second materials as well as composites comprising one or more of the aforementioned second electroactive materials.

In certain variations, the positive electroactive materials may be intermingled with an electrically conductive material that provides an electron conduction path and/or at least one polymeric binder material that improves the structural integrity of the electrode. For example, the electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. The positive electrode current collector 34 may be formed from aluminum (Al) or any other appropriate electrically conductive material known to those of skill in the art. The positive current collector 34 may be formed from aluminum or any other appropriate electrically conductive material known to those of skill in the art. In certain aspects, the positive electrode current collector 34 and/or negative electrode current collector 32 may be in the form of a foil, slit mesh, and/or woven mesh.

Electrically conductive materials, which may optionally be present in the negative electrode layer 22 and/or the positive electrode layer 24, may include carbon-based materials, powder or liquid metals, or a conductive polymer. Suitable electrically conductive material are well known to those of skill in the art and include, but are not limited to, carbon black, graphite, carbon nanotubes, carbon fibers, graphene, graphene oxide, acetylene black (such as KETCHEN™ black or DENKA™ black), nitrogen-doped carbon, metallic powder (e.g., copper, nickel, steel), liquid metals (e.g., Ga, GaInSn), and combinations thereof. Examples of a conductive polymer include polyaniline, polythiophene, polyacetylene, poly(pyrrole, and the like.

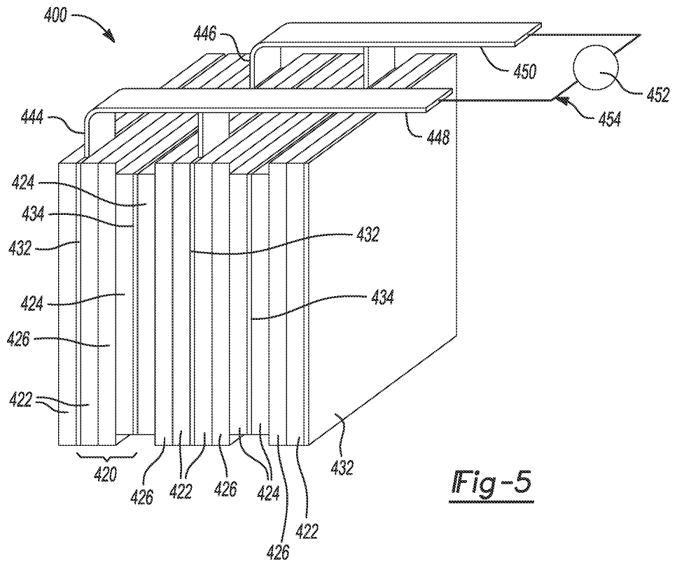

Referring now to FIG. 5, the electrochemical cell 20 (as shown in FIG. 1) may be combined with one or more other electrochemical cells to produce a lithium ion battery 400. The lithium ion battery 400 illustrated in FIG. 5 includes multiple rectangular-shaped electrochemical cells 420. Anywhere from 5 to 150 electrochemical cells 420 may be stacked side-by-side in a modular configuration and connected in series or parallel to form a lithium ion battery 400, for example, for use in a vehicle powertrain. The lithium ion battery 400 can be further connected serially or in parallel to other similarly constructed lithium ion batteries to form a lithium ion battery pack that exhibits the voltage and current capacity demanded for a particular application, e.g., for a vehicle. It should be understood the lithium ion battery 400 shown in FIG. 5 is only a schematic illustration, and is not intended to inform the relative sizes of the components of any of the electrochemical cells 420 or to limit the wide variety of structural configurations a lithium ion battery 400 may assume. Various structural modifications to the lithium ion battery 400 shown in FIG. 5 are possible despite what is explicitly illustrated.

Each electrochemical cell 420 includes a negative electrode 422, a positive electrode 424, and a separator 426 situated between the two electrodes 422, 424. Each of the negative electrode 422, the positive electrode 424, and the separator 416 is impregnated, infiltrated, or wetted with a liquid electrolyte capable of transporting lithium ions. A negative electrode current collector 432 that includes a negative polarity tab 444 is located between the negative electrodes 422 of adjacent electrochemical cells 420. Likewise, a positive electrode current collector 434 that includes a positive polarity tab 446 is located between neighboring positive electrodes 424. The negative polarity tab 444 is electrically coupled to a negative terminal 448 and the positive polarity tab 446 is electrically coupled to a positive terminal 450. An applied compressive force usually presses the current collectors 432, 434, against the electrodes 422, 424 and the electrodes 422, 424 against the separator 426 to achieve intimate interfacial contact between the several contacting components of each electrochemical cell 420.

The battery 400 may include one or more electrochemical cells 420, like electrochemical cell 20 depicted in FIG. 1, and one or more negative electrodes 422, like negative electrode 22 depicted in FIG. 2. In such cases, the one or more electrochemical cells 420 may each include a protective coating 48 including a first layer 50 and a second layer 54, all as described herein, disposed between confronting surfaces of porous separator 426 and negative electrode 422. Similarly, in such cases, the one or more negative electrodes 422 may each include a protective coating 48 including a first layer 50 and a second layer 54, all as described herein, adjacent to at least a portion of a first surface of the negative electrode 422. In some embodiments, a protective coating 48 may be disposed on or adjacent to a surface of one or more outermost negative electrodes 422, and not present on the interior negative electrodes 422. In other words, a protective coating 48 may be present between confronting surfaces of porous separator 426 and negative electrode 422 of one or more outermost electrochemical cells 420, and not present in the interior electrochemical cells 420. Alternatively, a protective coating 48 may be present in all the electrochemical cells 420 in battery 400.

The battery 400 may include two or more pairs of positive and negative electrodes 422, 424. In one form, the battery 400 may include 15-60 pairs of positive and negative electrodes 422, 424. In addition, although the battery 400 depicted in FIG. 5 is made up of a plurality of discrete electrodes 422, 424 and separators 426, other arrangements are certainly possible. For example, instead of discrete separators 426, the positive and negative electrodes 422, 424 may be separated from one another by winding or interweaving a single continuous separator sheet between the positive and negative electrodes 422, 424. In another example, the battery 400 may include continuous and sequentially stacked positive electrode, separator, and negative electrode sheets folded or rolled together to form a “jelly roll.”

The negative and positive terminals 448, 450 of the lithium ion battery 400 are connected to an electrical device 452 as part of an interruptible circuit 454 established between the negative electrodes 422 and the positive electrodes 424 of the many electrochemical cells 420. The electrical device 452 may comprise an electrical load or power-generating device. An electrical load is a power-consuming device that is powered fully or partially by the lithium ion battery 400. Conversely, a power-generating device is one that charges or re-powers the lithium ion battery 400 through an applied external voltage. The electrical load and the power-generating device can be the same device in some instances. For example, the electrical device 452 may be an electric motor for a hybrid electric vehicle or an extended range electric vehicle that is designed to draw an electric current from the lithium ion battery 400 during acceleration and provide a regenerative electric current to the lithium ion battery 400 during deceleration. The electrical load and the power-generating device can also be different devices. For example the electrical load may be an electric motor for a hybrid electric vehicle or an extended range electric vehicle and the power-generating device may be an AC wall outlet, an internal combustion engine, and/or a vehicle alternator.

The lithium ion battery 400 can provide a useful electrical current to the electrical device 452 by way of the reversible electrochemical reactions that occur in the electrochemical cells 420 when the interruptible circuit 454 is closed to connect the negative terminal 448 and the positive terminal 450 at a time when the negative electrodes 422 contain a sufficient quantity of intercalated lithium (i.e., during discharge). When the negative electrodes 422 are depleted of intercalated lithium and the capacity of the electrochemical cells 420 is spent, the lithium ion battery 400 can be charged or re-powered by applying an external voltage originating from the electrical device 452 to the electrochemical cells 420 to reverse the electrochemical reactions that occurred during discharge.

Although not depicted in the drawings, the lithium ion battery 400 may include a wide range of other components. For example, the lithium ion battery 400 may include a casing, gaskets, terminal caps, and any other desirable components or materials that may be situated between or around the electrochemical cells 420 for performance related or other practical purposes. For example, the lithium ion battery 400 may be enclosed within a case (not shown). The case may comprise a metal, such as aluminum or steel, or the case may comprise a film pouch material with multiple layers of lamination.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A negative electrode comprising:
a negative electrode layer comprising a first electroactive material; and
a protective coating adjacent to at least a portion of a first surface of the negative electrode layer,
wherein the protective coating comprises:
a first layer adjacent to at least a portion of the first surface of the negative electrode layer, wherein the first layer comprises:
a first polymeric binder; and
optionally, an insulating material selected from the group consisting of a lithium ion conductive material, a ceramic filler material, and a combination thereof;
wherein the first layer has an electronic conductivity of less than or equal to about 10⁻⁵ S/cm; and
a second layer adjacent to at least a portion of a second surface of the first layer, wherein the second layer comprises:
a second polymeric binder; and
a dendrite consuming material selected from the group consisting of a lithium ion host material, a capacitor material, a lithium reactive metal, a lithium reactive inorganic component, and a combination thereof.

2. The negative electrode of claim 1, wherein the first electroactive material is selected from the group consisting of lithium, a lithium silicon alloy, a lithium aluminum alloy, a lithium indium alloy, graphite, activated carbon, carbon black, hard carbon, soft carbon, graphene, silicon, silicon alloy, tin oxide, aluminum, indium, zinc, germanium, silicon oxide, titanium oxide, lithium titanate, and a combination thereof.

3. The negative electrode of claim 1, wherein the first polymeric binder is present in the first layer in an amount of about 0.5 wt % to about 100 wt %, based on total weight of the first layer, and the insulating material is present in the first layer in an amount of about 0 wt % to about 99.5 wt %, based on total weight of the first layer.

4. The negative electrode of claim 1, wherein first polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof;
wherein the lithium ion conductive material is selected from the group consisting of a garnet ceramic material, a lithium super ionic conductor (LISICON) oxide, a sodium super ionic conductor (NASICON) oxide, a perovskite ceramic material, an antiperovskite ceramic material and a combination thereof; and
the ceramic filler material is selected from the group consisting of SiO₂, Al₂O₃, TiO₂, AlN, Al₂O₃, SiC, Si₃N₄, Sr₂Ce₂Ti₅O₁₆, ZrSiO₄, CaSiO₃, SiO₂, BeO, CeO₂, BN, ZnO, and a combination thereof.

5. The negative electrode of claim 1, wherein the second polymeric binder is present in the second layer in an amount of about 0.5 wt % to about 5 wt %, based on total weight of the second layer, and the dendrite consuming material is present in the second layer in an amount of about 90 wt % to about 99.5 wt %, based on total weight of the second layer.

6. The negative electrode of claim 1, wherein the second polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof;
wherein the lithium ion host material is selected from the group consisting of Li₄Ti₅O₁₂, TiₓNb_{y}O_{z} where 1/24≤x/y≤1 and z=(4*x+5*y)/2, TiS₂, TiO₂, Nb₂O₅, and a combination thereof;
wherein the capacitor material is selected from the group consisting of activated carbon, a metal oxide, a metal sulfide, a conductive polymer, and a combination thereof;
wherein the lithium reactive metal is selected from the group consisting of tin, manganese, aluminum, sulfur, silver-carbon, and a combination thereof; and
the lithium reactive inorganic component is selected from the group consisting of Li₁₊ₓAlₓTi₂₋ₓ(PO₄)₃ where 0≤x≤2.

7. The electrode of claim 1, wherein the second layer further comprises an electrically conductive material selected from the group consisting of carbon black, super P carbon black, acetylene black, graphite, carbon nanotubes, carbon fibers, graphene, graphene oxide, vapor grown carbon fibers, nitrogen-doped carbon, a metallic powder, a liquid metal, and combinations thereof; and
wherein the electrically conductive material is present in the second layer in an amount of about 0.5 wt % to about 5 wt %, based on total weight of the second layer.

8. The negative electrode of claim 1, wherein the insulating material has an average particle size diameter of about 20 nm to about 500 nm and the dendrite consuming material has an average particle size diameter of about 20 nm to about 500 nm.

9. The negative electrode of claim 1, wherein the first layer has a thickness of about 1 μm to about 10 μm and the second layer has a thickness of about 1 μm to about 10 μm.

10. An electrochemical cell comprising:
a negative electrode layer comprising a first electroactive material:
a positive electrode layer comprising a second electroactive material, wherein the positive electrode layer is spaced apart from the negative electrode layer;
a porous separator disposed between confronting surfaces of the negative electrode layer and the positive electrode layer;
at least one protective coating disposed between confronting surfaces of the porous separator and the negative electrode layer,
wherein the protective coating comprises:
a first layer adjacent to at least a portion of a first surface of the negative electrode layer, wherein the first layer comprises:
a first polymeric binder; and
optionally, an insulating material selected from the group consisting of a lithium ion conductive material, a ceramic filler material, and a combination thereof;
wherein the first layer has an electronic conductivity of less than or equal to about 10⁻⁵ S/cm; and
a second layer adjacent to at least a portion of a second surface of the first layer, wherein the second layer comprises:
a second polymeric binder; and
a dendrite consuming material selected from the group consisting of a lithium ion host material, a capacitor material, a lithium reactive metal, a lithium reactive inorganic component, and a combination thereof;
and
a liquid electrolyte infiltrating the negative electrode layer, the positive electrode layer, and the porous separator.

11. The electrochemical cell of claim 10, wherein the first electroactive material is selected from the group consisting of lithium, a lithium silicon alloy, a lithium aluminum alloy, a lithium indium alloy, graphite, activated carbon, carbon black, hard carbon, soft carbon, graphene, silicon, silicon alloy, tin oxide, aluminum, indium, zinc, germanium, silicon oxide, titanium oxide, lithium titanate, and a combination thereof; and
wherein the second electroactive material is selected from the group consisting of Li₍₁₊ₓ₎Mn₂O₄, where 0.1≤x≤1; LiMn₍₂₋ₙ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FePO₄F; LiMn₂O₄; LiFeSiO₄; LiNi_{0.6}Mn_{0.2}Co_{0.2}O₂ (NMC622), LiMnO₂ (LMO), activated carbon, sulfur, and a combination thereof.

12. The electrochemical cell of claim 10, wherein the first layer is formed on the first surface of the negative electrode layer and the second layer is formed on the second surface of the first layer; or wherein the first layer is formed on the first surface of the negative electrode layer and the second layer is formed on a third surface of the porous separator; or wherein the second layer is formed on the third surface of the porous separator and the first layer is formed on a fourth surface of the second layer.

13. The electrochemical cell of claim 10, wherein the first polymeric binder is present in the first layer in an amount of about 0.5 wt % to about 100 wt %, based on total weight of the first layer, and the insulating material is present in the first layer in an amount of about 0 wt % to about 99.5 wt %, based on total weight of the first layer.

14. The electrochemical cell of claim 10, wherein first polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof;
wherein the lithium ion conductive material is selected from the group consisting of a garnet ceramic material, a lithium super ionic conductor (LISICON) oxide, a sodium super ionic conductor (NASICON) oxide, a perovskite ceramic material, an antiperovskite ceramic material and a combination thereof; and
the ceramic filler material is selected from the group consisting of SiO₂, Al₂O₃, TiO₂, AlN, Al₂O₃, SiC, Si₃N₄, Sr₂Ce₂Ti₅O₁₆, ZrSiO₄, CaSiO₃, SiO₂, BeO, CeO₂, BN, ZnO, and a combination thereof.

15. The electrochemical cell of claim 10, wherein the second polymeric binder is present in the second layer in an amount of about 0.5 wt % to about 5 wt %, based on total weight of the second layer, and the dendrite consuming material is present in the second layer in an amount of about 90 wt % to about 99.5 wt %, based on total weight of the second layer.

16. The electrochemical cell of claim 10, wherein the second polymeric binder is selected from the group consisting of polyvinylidene fluoride (PVDF), poly(vinylidene fluoride-co-hexafluoropropylene) (PVDF-HFP), ethylene propylene diene monomer (EPDM) rubber, styrene butadiene rubber (SBR), carboxymethyl cellulose (CMC), polyethylene glycol (PEG), polyethylene oxide (PEO), poly(p-phenylene oxide) (PPO), poly(methyl methacrylate) (PMMA), polyacrylonitrile (PAN), polyvinyl chloride (PVC), polyacrylic acid, and a combination thereof;
wherein the lithium ion host material is selected from the group consisting of Li₄Ti₅O₁₂, TiₓNb_{y}O_{z} where 1/24≤x/y≤1 and z=(4*x+5*y)/2, TiS₂, TiO₂, Nb₂O₅, and a combination thereof;
wherein the capacitor material is selected from the group consisting of activated carbon, a metal oxide, a metal sulfide, a conductive polymer, and a combination thereof;
wherein the lithium reactive metal is selected from the group consisting of tin, manganese, aluminum, sulfur, silver-carbon, and a combination thereof; and
the lithium reactive inorganic component is selected from the group consisting of Li₁₊ₓAlₓTi₂₋ₓ(PO₄)₃ where 0≤x≤2.

17. The electrochemical cell of claim 10, wherein the second layer further comprises an electrically conductive material selected from the group consisting of carbon black, super P carbon black, acetylene black, graphite, carbon nanotubes, carbon fibers, graphene, graphene oxide, vapor grown carbon fibers, nitrogen-doped carbon, a metallic powder, a liquid metal, and combinations thereof; and
wherein the electrically conductive material is present in the second layer in an amount of about 0.5 wt % to about 5 wt %, based on total weight of the second layer.

18. The electrochemical cell of claim 10, wherein the insulating material has an average particle size diameter of about 20 nm to about 500 nm and the dendrite consuming material has an average particle size diameter of about 20 nm to about 500 nm.

19. The electrochemical cell of claim 10, wherein the first layer has a thickness of about 1 μm to about 10 μm and the second layer has a thickness of about 1 μm to about 10 μm.
